(19) United States
(12) Patent Application Publication
(10) Pub. No.: US 2013/0194628 A1
(43) Pub. Date: Aug. 1, 2013

(54) IMAGE PROCESSING SYSTEM, INFORMATION TERMINAL APPARATUS, IMAGE DISPLAYING METHOD, AND PROGRAM

(71) Applicant: Hiroshi KAMIMOTO, Kanagagwa (JP)

(72) Inventor: Hiroshi KAMIMOTO, Kanagagwa (JP)

(73) Assignee: RICOH COMPANY, LTD.

(21) Appl. No.: 13/746,665

(22) Filed: Jan. 22, 2013

(30) Foreign Application Priority Data
Jan. 31, 2012 (JP) 2012-017985

(51) Int. Cl. G06F 3/12

(52) U.S. Cl. CPC G06F 3/1286
USPC 358/1.15

(57) ABSTRACT

A disclosed image processing system includes a first apparatus; and a second apparatus connected to the first apparatus via a network, wherein the first apparatus includes a screen definition information sending unit sending screen definition information defining an operations screen for using a function, which can be used, an operations information receiving unit receiving an execution request issued on the second apparatus using the operations screen, and an execution controlling unit controlling execution of the function in response to the execution request, wherein the second apparatus includes a building unit building the operations screen in conformity with the screen definition information which is received, an operations receiving unit receiving an operation using the operations screen, and an operations information sending unit sending the execution request in response to an execution instruction operation for requesting the first apparatus to execute the function based on the received operation.

### BACKGROUND OF THE INVENTION

1. Field of the Invention

The present invention generally relates to a user interface of an image processing apparatus, and more specifically, to an image processing system, an information terminal apparatus, an image displaying method, and a program.

2. Description of the Related Art

In recent years, image processing apparatuses of various specifications are provided. Such image processing apparatuses include a small display device such as a four line liquid crystal display (LCD) or a large color display device such as a Wide Video Graphics Array (WVGA). Under the above background, in order to deal with various specifications and future function expansions, it is known that an integrated user interface (hereinafter, referred to as UI) definition file is made. On a side of the image processing apparatus, an operations screen onto which display characteristics or functional characteristics of a display device included in the image processing apparatus are reflected is built and displayed in conformity with a UI definition file.

For example, Patent Document 1 discloses a technique in which characteristic information of the operations panel is acquired in a program run by each multifunction peripheral included in a document delivery system, and a UI is displayed in conformity with the characteristic information of the operations panel. Patent Document 2 discloses a technique in which original screen definition data for defining an operations screen using a delivery flow is made of one process or greater provided to an electronic document.

According to Patent Document 2, a portion defining a display content to be changed depending on the performance of received original screen definition data is modified in conformity with capability information describing the performance performed by the document delivery system, and an operations screen in conformity with the revised screen definition data in using a delivery flow.

It is possible to provide a UI suitable for the operations panels by using an integrated UI definition file depending on a function of performing UI building on the above image processing apparatus. For example, on an operations panel having a high resolution, it is possible to realize a Graphical User Interface (GUI) with which an operation procedure can be intuitively known using an image, a drawing or a table as illustrated in FIG. 16A. On the other hand, on the operations panel having a low resolution, it is possible to realize a Character User Interface (CUI) with which the minimum operation is enabled as illustrated in FIG. 16B.

Patent Document 3 is known as another technique of integrating UI screens of plural image forming apparatuses. Patent Document 3 refers to a technique of externally attaching an extended UI device having a touch panel type liquid crystal display device to each image forming apparatus, building a LAN by connecting the extended UI devices to a server via a communication medium, and causing a Web browser of the extended UI device to acquire an HTML file so as to display a UI screen on the touch panel.

However, the above related arts are insufficient because of the following points. With the related arts described in the Patent Documents 1 and 2, a sufficient UI cannot be provided by an image processing apparatus having an operations panel having only an extremely inferior drawing performance. Therefore, user-friendliness is degraded. Further, with an image forming apparatus without a display device, a part of functions of the document delivery system or the like cannot be built so as to be usable. Thus, user-friendliness is degraded. Said differently, since the related arts described in the Patent Documents 1 and 2 relate to the UI operations on the operations panels included in the multifunction peripherals, it is not possible to deal with cases where only the operations panel having the extremely inferior drawing performance is provided and the display device is not installed.

Further, with the related art described in the Patent Document 3, the extended UI device causes plural image forming apparatuses to display an average UI screen. Therefore, expandability is too poor to apply the average UI screen to a document delivery system, in which many workflows and operations screens undergo user definitions, or the like.
Patent Document 1: Japanese Patent No. 4539293
Patent Document 2: Japanese Laid-Open Patent Application No. 2011-186789
Patent Document 3: Japanese Laid-Open Patent Application No. 2009-188582

### SUMMARY OF THE INVENTION

Accordingly, embodiments of the present invention provide a novel and useful image processing system, an information terminal apparatus, an image displaying method, and a program, which enable an operations screen for a first apparatus to be displayed on a second apparatus connected to the first apparatus via a network so that an input operation is enabled from the second apparatus to the first apparatus, solving one or more of the problems discussed above.

One aspect of the embodiments of the present invention may be to provide an image processing system including a first apparatus; and a second apparatus connected to the first apparatus via a network, wherein the first apparatus includes a screen definition information sending unit configured to send screen definition information defining an operations screen for using a function, which can be used, from the first apparatus to the second apparatus, an operations information receiving unit configured to receive an execution request issued on the second apparatus using the operations screen, and an execution controlling unit configured to control execution of the function in response to the execution request, wherein the second apparatus includes a building unit configured to build the operations screen in conformity with the screen definition information which is received, an operations receiving unit configured to receive an operation using the operations screen, and an operations information sending unit configured to send the execution request to the first apparatus in response to an execution instruction operation for requesting the first apparatus to execute the function based on the operation received by the operations receiving unit.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 schematically illustrates a network environment of a document delivery system of a first embodiment;

FIG. 2A illustrates the hardware structure of a multifunction peripheral of the first embodiment;

FIG. 2B illustrates the hardware structure of an information terminal apparatus;

FIG. 3 is a functional block chart realized by the document delivery system of the first embodiment;

FIG. 4 is a flow chart illustrating a screen display operating process performed by an information terminal apparatus of the first embodiment;

FIG. 5 is a sequence chart illustrating a screen display operating process performed between a multifunction peripheral and the information terminal apparatus of the first embodiment;

FIG. 6 is a sequence chart illustrating a screen display operating process performed between a multifunction peripheral and an information terminal apparatus of a modified example of the first embodiment;

FIG. 7A illustrates an exemplary initial screen of a remote operations panel displayed on a display unit of the information terminal apparatus;

FIG. 7B illustrates an exemplary remote operations panel screen of the remote operations panel displayed on the display unit of the information terminal apparatus;

FIG. 8 illustrates an exemplary data structure of screen definition information of the first embodiment;

FIG. 9 is a functional block chart realized by a document delivery system of a second embodiment;

FIG. 10 is a sequence chart illustrating a screen display operating process performed between a multifunction peripheral and an information terminal apparatus of the second embodiment;

FIG. 11 illustrates an exemplary data structure of capability information of the second embodiment;

FIG. 12A illustrates an exemplary remote operations panel screen displayed on a display unit of the information terminal apparatus;

FIG. 12B illustrates another exemplary remote operations panel screen displayed on a display unit of the information terminal apparatus;

FIG. 13 is a sequence chart illustrating a screen display operating process performed between a multifunction peripheral and an information terminal apparatus of a third embodiment;

FIG. 14 is another sequence chart illustrating the screen display operating process performed between the multifunction peripheral and the information terminal apparatus of the third embodiment following FIG. 13;

FIG. 15 schematically illustrates a network environment of a document delivery system of another embodiment; and

FIG. 16A illustrates an exemplary GUI screen displayed on an operations panel of a multifunction peripheral; and

FIG. 16B illustrates an exemplary CUI screen displayed on the operations panel of the multifunction peripheral.

### DETAILED DESCRIPTION OF THE PREFERRED EMBODIMENTS

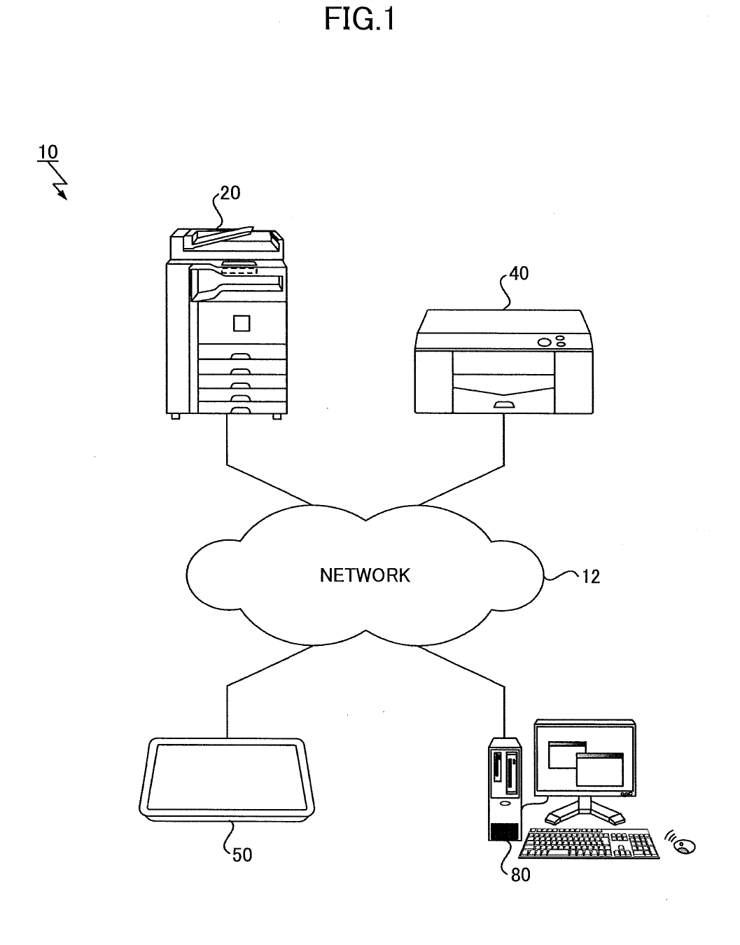

A description is given below, with reference to the FIG. 1 through FIG. 10 of embodiments of the present invention. Where the same reference symbols are attached to the same parts, repeated description of the parts is omitted.

Reference symbols typically designate as follows:
10, 500: document delivery system;
12, 512: network;
20, 40, 520, 540: multifunction peripheral;
22: control unit;
24: main memory unit;
26: auxiliary memory unit;
28: external memory apparatus I/F unit;
30: network I/F unit;
32: engine unit;
34: operations panel unit;
50, 550: information terminal apparatus;
52: control unit;
54: main memory unit;
56: auxiliary memory unit;
58: external memory apparatus I/F unit;
60: network I/F unit;
62: input unit;
64: display unit;
80, 580: control terminal;
100, 120, 150, 300, 320, 350: functional block;
122, 322: remote communication unit;
124, 324: remote operations panel providing unit;
126, 326: screen definition information holding unit;
128, 328: UI building unit;
130, 330: UI displaying unit;
132, 332: UI operations receiving unit;
140, 340: operations information receiving unit;
142, 342: screen definition information sending unit;
134, 334: flow controlling unit;
152, 352: remote communication unit;
154, 354: remote operations panel unit;
160, 360: screen definition information receiving portion;
162, 362: screen definition information holding unit;
164, 364: UI building unit;
166, 366: UI displaying unit;
168, 368: UI operations receiving unit;
170, 370: setup information holding unit;
172, 372: operations information sending unit;
200: initial screen;
202: displayed message;
204: connection destination administrating button;
206: connection destination designating button;
220, 250, 260: remote operations panel screen;
222: disconnecting button;
224: operations screen display area;
226: start button;
230: title display;
232, 234, 236, 240: button;
238: tab;
242, 244: scroll button;
252, 254, 262, 264: options group;
256, 258: options
336: capability information holding unit;
344: capability information sending unit;
374: capability information receiving unit;
376: capability information holding unit; and
590: document delivery server.

Hereinafter, a description of embodiments is described. However, the embodiments of the present invention are not limited to the following embodiments. Within the embodiment described below, an exemplary image processing system including an image processing apparatus (a first apparatus), an information terminal apparatus (a second apparatus), and programs installed in the image processing apparatus and the information terminal apparatus are described. The exemplary image processing system is a document delivery system including programs realizing a multifunction peripheral and an information terminal apparatus.

FIG. 1 schematically illustrates a network environment of a document delivery system of the first embodiment. The document delivery system 10 includes multifunction peripherals 20 and 40 mutually connected via a network 12, an information terminal apparatus 50, and a control terminal 80. The network 12 is not specifically limited. However, the network 12 is formed as a wired network, a wireless network, or a mixture of the wired and wireless networks such as a Local Area Network (LAN) (e.g., Transmission Control Protocol/Internet Protocol (TCP/IP) or Ethernet (“Ethernet” is a registered trademark)) or a Wide Area Network (WAN).

The multifunction peripherals 20 and 40 are image forming apparatus for providing various image processing services such as copying, scanning, printing, or faxing. For example, the multifunction peripheral 20 may have a display device such as a four line liquid crystal display (LCD) or a WVGA including an operations panel. On the other hand, for example, the multifunction peripheral 40 may not include a display device or may include an operations panel having only a limited drawing performance. The image processing apparatus is not limited to a multifunction peripheral, and may be various apparatuses handling images such as a copier, a printing machine, a scanner, a facsimile apparatus, a printer apparatus, or the like.

Within the Embodiments disclosed herein, the multifunction peripherals 20 and 40 are operated as an image input apparatus in the document delivery system 10. Said differently, the multifunction peripherals 20 and 40 brings input images such as a scanned image, an image received for printing, and an image received by faxing in conformity with a predetermined delivery flow to provide a predetermined process and deliver to a predetermined delivery destination.

The administrating control terminal 80 is a terminal operated by a system administrator. The administrating control terminal 80 provides various administrating tools for administrating the document delivery system 10. The various administrating tools are, for example, document delivery flow designing tools for defining the document delivery flow and various operations screens for using the document delivery flow. The document delivery flow is defined as a sequential processing flow including an input, an intermediate process (when appropriate), and an output. Further, various operations screens are defined to use the document delivery flow in conformity with the definition of the document delivery flow.

An input in the above document delivery flow is a scanning input, a facsimile receipt, an accumulated image file input (including a previously read scanned image, a previously received print image, a previously received facsimile receipt image, or the like) in the multifunction peripheral 20. The output is electronic mail transmission, storage in a network shared folder, registration in a document administration system, or the like. The intermediate process includes various image processes such as an optical character recognition (OCR) process or a frame removing process. The operations screen is provided to select scanning parameters including designation of a screen graphic mode, designation of a color mode, or the like or the address of a delivery destination.

In the document delivery system 10 of the embodiment, the document delivery flow is described in each of the flow definition information. The operation screen is described in each of the screen definition information. The above flow definition information and the screen definition information are delivered from the administrating control terminal 80 to the multifunction peripherals 20 and 40 via the network 12. In the multifunction peripherals 20 and 40 receiving the flow definition information and the screen definition information, the flow definition information and the screen definition information are stored and the document delivery flow is structured so as to be used. The screen definition information may be a single file describing plural operations screens mutually transit or files corresponding to the operations screens. In a manner similar to the above, the flow definition information may be a single file describing the plural delivery flows or files corresponding to the delivery flows.

Within the embodiment, the multifunction peripherals have mutually different drawing performance. However, it is not appropriate to prepare the screen definition information in conformity with all types of the multifunction peripherals in view of the work burden of the system administrator and future expandability. Therefore, the administrating tool of the embodiment forms the screen definition information as the same file. In the multifunction peripherals 20 and 40, the operations screen suitable for the drawing performance of the operations panel installed in each multifunction peripheral is built in conformity with the screen definition information. Thus, even if the same file is used, it is possible to display a GUI enabling an intuitive operation on the operations panel of the multifunction peripheral having the sufficient drawing performance and to display a simple CUI on the operations panel of the multifunction peripheral without sufficient drawing performance.

The multifunction peripherals 20 and 40 of the embodiment respectively provide remote operations functions for remotely operating the multifunction peripheral from the outer information terminal apparatus via the network 12. The information terminal apparatus 50 runs a program of the embodiment. The information terminal apparatus 50 is connected to a remote operations function of the multifunction peripheral (e.g., 20) to display the remote operations panel on the display device of the information terminal apparatus 50. The information terminal apparatus 50 receives an input operation at a remote operations panel via an input device of the information terminal apparatus 50 to enable remote operations of the multifunction peripheral 20.

### First Embodiment

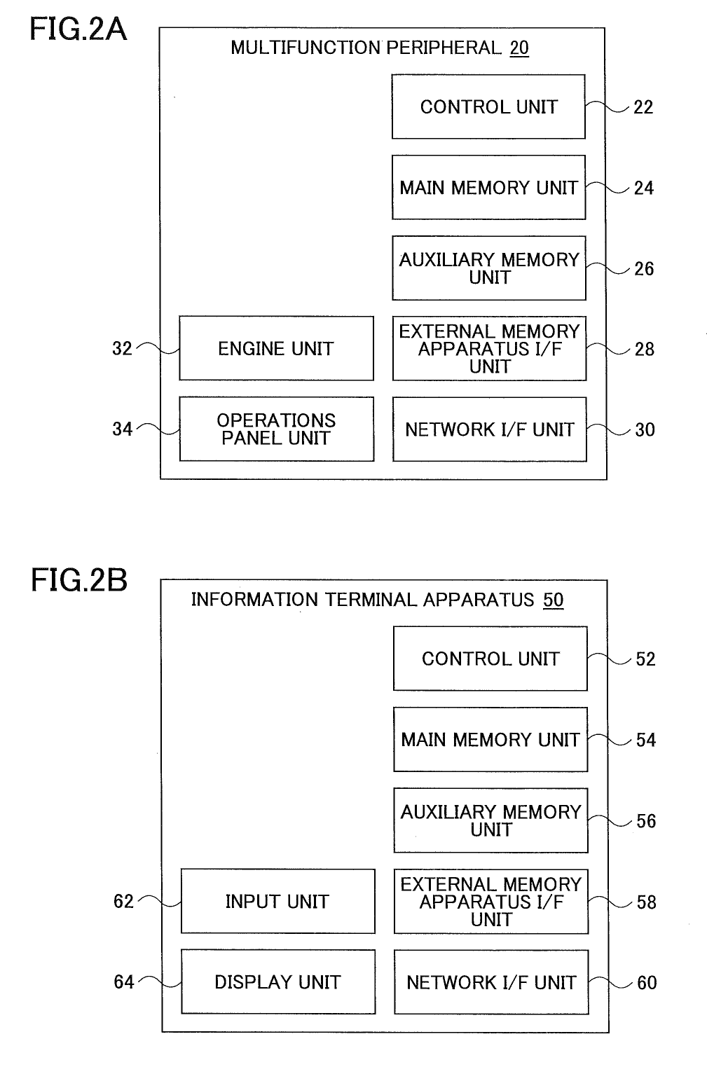

Hereinafter, referring to FIGS. 2A and 2B, the hardware structures of the multifunction peripheral and the information terminal apparatus of the first embodiment are described. FIG. 2A illustrates the hardware structure of the multifunction peripheral of the first embodiment. FIG. 2B illustrates the hardware structure of the information terminal apparatus. The multifunction peripheral (hereinafter, the multifunction peripheral 20 is referred on behalf of multifunction peripherals) illustrated in FIG. 2A includes a control unit 22 including a central processing unit (CPU) and a main memory unit 24 such as a random access memory (RAM). The multifunction peripheral 20 further includes an auxiliary memory unit 26 such as a hard disk drive (HDD) or a solid state drive (SSD), an external memory apparatus I/F unit 28, a network I/F unit 30 such as a network interface card (NIC), an engine unit 32, and an operations panel unit 34.

The auxiliary memory unit 26 accumulates image data, document data, programs, font data, and form data and stores control programs such as an OS and software for controlling the multifunction peripheral 20, various system information, and various setup information. The external memory apparatus I/F unit 28 is an interface device for connecting to an external memory media such as a USB flash memory, a smart media (“smart media” is a registered trademark), an SD memory card (“SD memory card” is a registered trademark), or the like. The network I/F unit 30 is an interface device for connecting the multifunction peripheral 20 to the network 12.

The engine unit 32 includes a plotter engine using electrophotography or the like and a scanner engine using a charge coupled device (CCD) method, a contact image sensor (CIS) method, or the like. The engine unit 32 performs image input and print output in the required document delivery flow. The operations panel unit 34 includes a display device such as a liquid crystal display, or the like and an input device such as keypads (hard keys), a touch panel, or the like. The operations panel unit 34 provides a user interface for receiving inputs of various instructions from an operator of the multifunction peripheral 20. The multifunction peripheral 20 reads various programs from the auxiliary memory unit 26 and expands the read programs onto a workspace provided by the main memory unit 24 to realize various functional parts and various processes under a control of the control unit 22.

The information terminal apparatus 50 may be a general-purpose computer such as a desktop, a laptop, or a mobile personal computer, or the like or a portable information terminal such as a smart phone, a tablet computer, a personal digital assistance (PDA), or the like. Referring to FIG. 2B, the information terminal apparatus 50 includes a control unit 52 including a CPU of a single core or a multi core, a main memory unit 54 such as a RAM or the like, an auxiliary memory unit 56 including an HDD or an SSD, an external memory apparatus I/F unit 58, and a network I/F unit 60.

The information terminal apparatus 50 further includes an input unit 62 and a display unit 64. The information terminal apparatus 50 provides a user interface for receiving inputs of various instructions from the operator of the information terminal apparatus 50. The input unit 62 includes the input device such as a mouse, a keyboard, a touch panel, or the like. The display unit 64 includes a display device such as a LCD display, an organic electro-luminescence (EL) display, or the like. The information terminal apparatus 50 reads an OS or programs for realizing the information terminal apparatus from an auxiliary memory unit 56 and expands the read programs onto the workspace provided by the main memory unit 54 thereby realizing various functional parts and various processes under a control of the control unit 52. The administrating control terminal 80 may employ the structure similar to the information terminal apparatus 50.

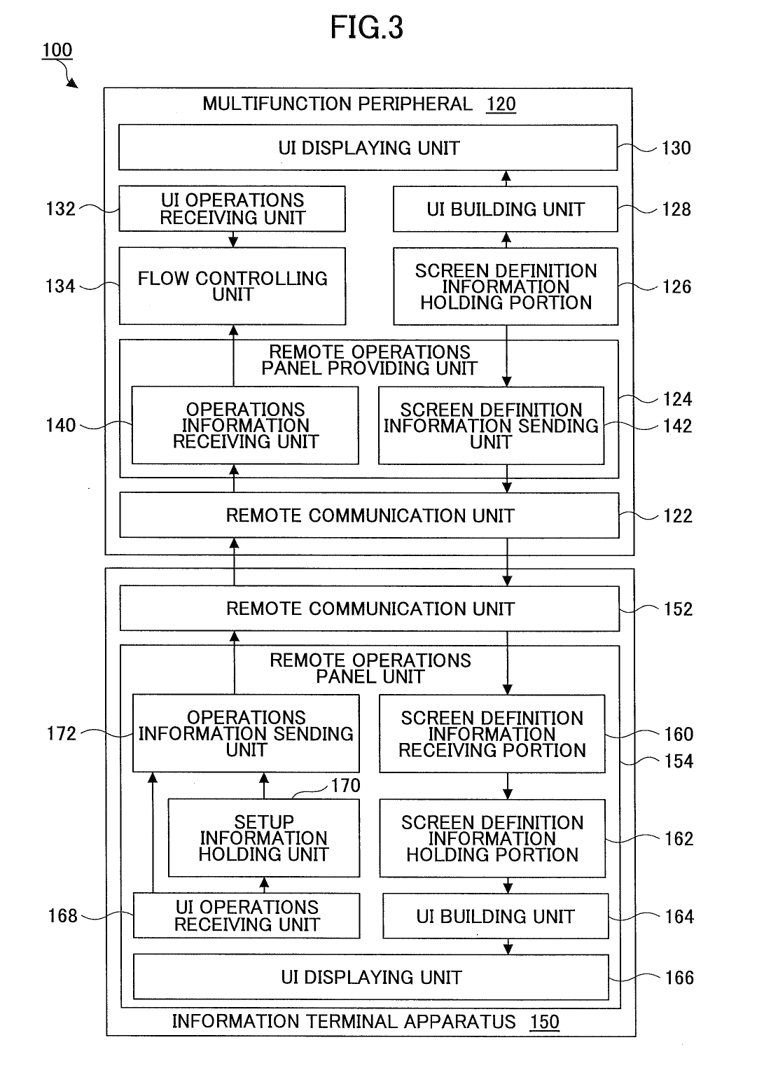

The document delivery system 10 of the first embodiment provides the remote operations function for using the document delivery flow by remotely connecting to the multifunction peripheral (e.g., the multifunction peripheral 20) from the information terminal apparatus 50. Hereinafter, referring to FIGS. 3 to 8, details of the remote operations function of the document delivery system 10 of the first embodiment are described. FIG. 3 illustrates a functional block realized by the document delivery system of the first embodiment. The multifunction peripheral (hereinafter, the multifunction peripheral 20 is referred on behalf of multifunction peripherals) illustrated in FIG. 3 includes a functional block 120 realized on the multifunction peripheral and a functional block 150 realized on the information terminal apparatus 50.

The functional block of the multifunction peripheral 20 includes a remote communication unit 122, a remote operations panel providing unit 124, a screen definition information holding unit 126, and a flow controlling unit 134. Referring to FIG. 3, the multifunction peripheral 20 includes an operations panel for displaying UI. The functional block 120 further includes a UI building unit 128, a UI displaying unit 130, and a UI operations receiving unit 132.

The remote communication unit 122 controls the network I/F unit 30 illustrated in FIG. 2A so as to administrate communications with the information terminal apparatus 50 provided outside. The remote operations panel providing unit 124 provides a remote operations function for remotely operating the multifunction peripheral 20 from the information terminal apparatus 50 provided outside. The screen definition information holding unit 126 is provided from a memory area of a memory apparatus. Screen definition information, which is provided by the memory area of the memory apparatus, delivered by the administrating control terminal 80, and defines an operations screen for using a usable function of the multifunction peripheral 20, is held. The flow controlling unit 134 calls a function (a delivery flow) in response to an execution request. The flow controlling unit 134 controls an execution of processes of the document delivery flow, which is subject to an execution request in conformity with a flow definition information, which is delivered along with the screen definition information from the administrating control terminal 80.

The UI building unit 128 reads the screen definition information held by the screen definition information holding unit 126. The UI building unit 128 builds an operations screen suitable for the drawing performance (e.g., a screen graphic mode, the number of colors, and usable GUI parts) of the display device of the multifunction peripheral 20. The UI displaying unit 130 displays the built operations screen on the display device of the operations panel unit 34. The UI operations receiving unit 132 receives an input operation effected on the operations screen via the operations panel unit 34 of the multifunction peripheral 20. The UI operations receiving unit 132 holds setup information input via the operations screen, issues an execution request, and sends the execution request and the setup information to the flow controlling unit 134 in response to pushing of a start key among the keypads (hard keys). In a case where a multifunction peripheral by which a UI cannot be displayed, the UI building unit 128, the UI displaying unit 130, and the UI operations receiving unit 132 are not provided.

The flow controlling unit 134 illustrated in FIG. 3 can receive the execution request from the operations panel unit 34 of the multifunction peripheral 20. Further, the flow controlling unit 134 can receive an execution request from the remote operations panel provided outside. Specifically, the remote operations panel providing unit 124 includes an operations information receiving unit 140 and a screen definition information sending unit 142. The screen definition information sending unit 142 sends the screen definition information held by the screen definition information holding unit 126 to the information terminal apparatus 50 connected to the remote operations function of the multifunction peripheral 20. The operations information receiving unit 140 receives setup information input via the remote operations panel from the information terminal apparatus 50 connected to the remote operations function of the multifunction peripheral 20. The operations information receiving unit 140 receives the execution request input via the remote operations panel, issues an execution request, and sends the execution request and the setup information to the flow controlling unit 134.

The functional block 150 of the information terminal apparatus 50 includes a remote communication unit 152 administrating communications with the multifunction peripheral 20 provided outside by controlling the network I/F unit 60 illustrated in FIG. 2B, and a remote operations panel unit 154. The remote operations panel unit 154 is an application for using the remote operations function provided by the multifunction peripheral 20 provided outside. The program of the remote operations panel unit 154 is previously installed in the information terminal apparatus 50. The remote operations panel unit 154 includes a screen definition information receiving portion 160, a screen definition information holding unit 162, a UI building unit 164, a UI displaying unit 166, a UI operations receiving unit 168, a setup information holding unit 170, and an operations information sending unit 172.

The screen definition information receiving portion 160 receives the screen definition information from the screen definition information sending unit 142 of the multifunction peripheral 20. The screen definition information holding unit 162 holds the received screen definition information. The UI building unit 164 reads the screen definition information held by the screen definition information holding unit 162. In conformity with the description, the operations screen suitable for the drawing performance of the display unit 64 of the information terminal apparatus 50 is built. The UI displaying unit 166 displays the built operations screen on the display unit 64. The UI operations receiving unit 168 receives an input operation effected on the operations screen via the input unit 62. The UI operations receiving unit 168 holds the setup information input via the operations screen in the setup information holding unit 170. The UI operations receiving unit 168 further calls the operations information sending unit 172 in response to operation of the remote operations panel. The operations information sending unit 172 reads the setup information in response to the call, and sends an execution request and the read setup information to the multifunction peripheral 20 on the connection destination.

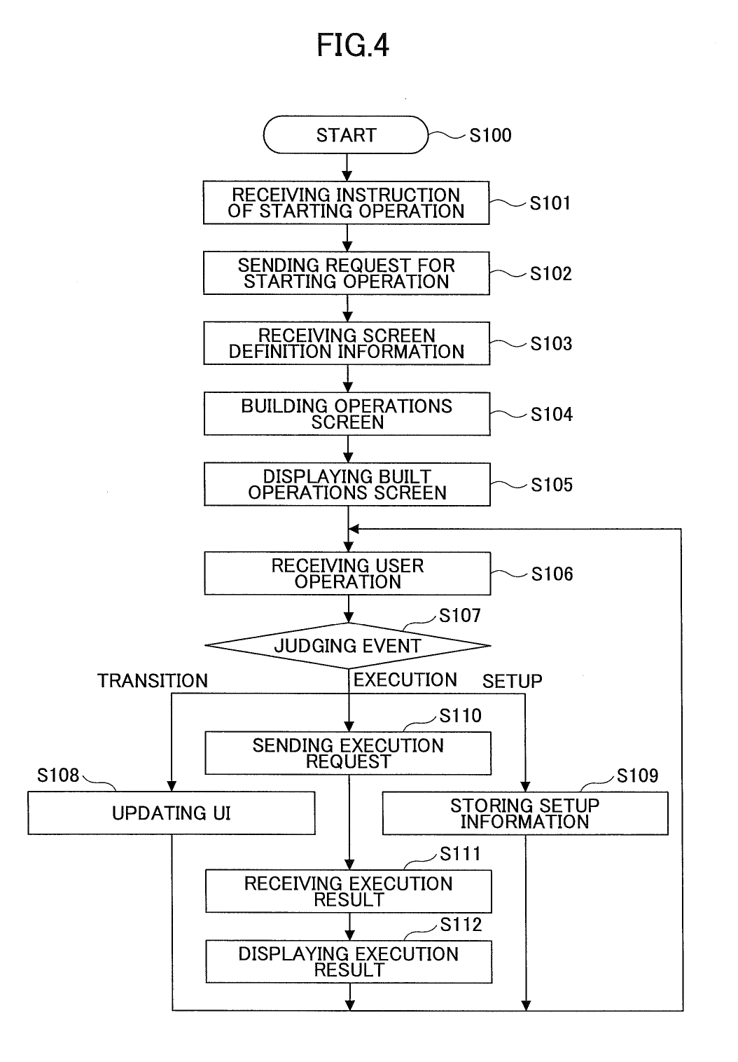

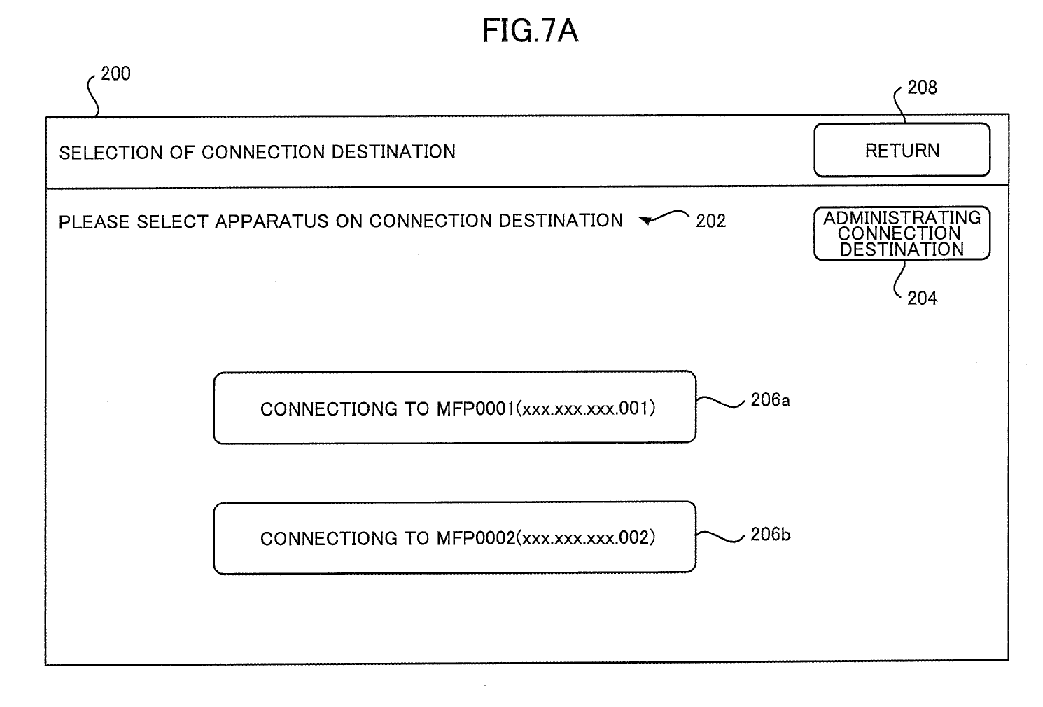

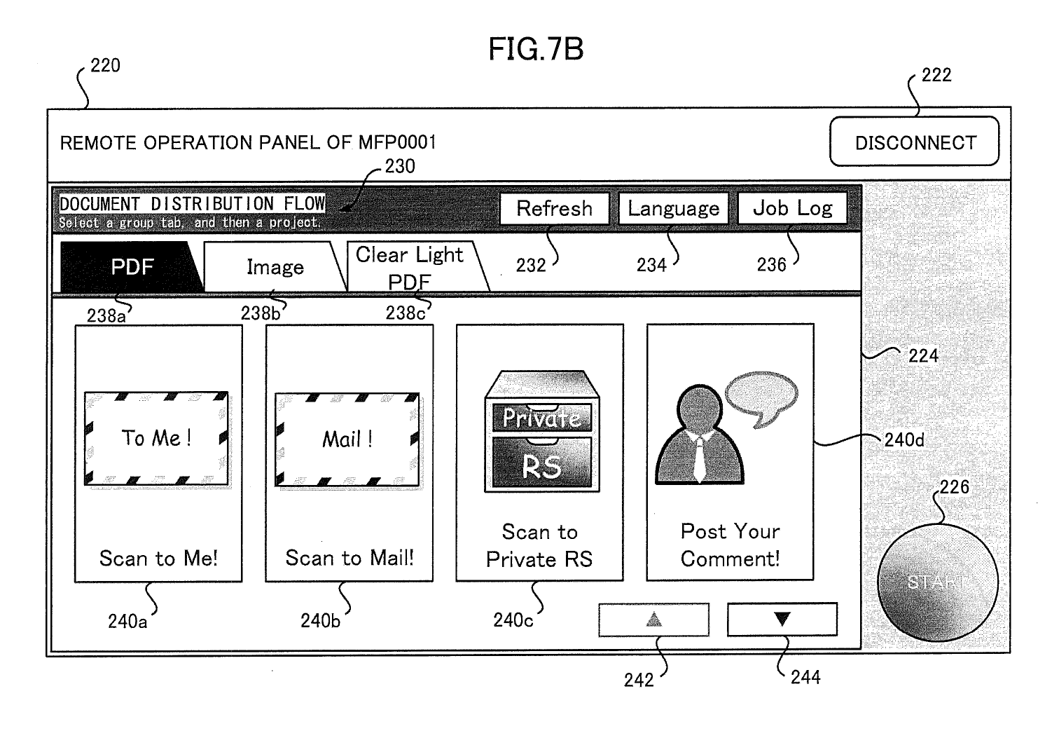

Referring to FIGS. 4-6, within the first embodiment, the process in the remote operations function performed between the information terminal apparatus 50 and the multifunction peripheral 20 is described in detail. FIG. 4 is a flow chart illustrating a screen display operating process performed by the information terminal apparatus 50 of the first embodiment. The process illustrated in FIG. 4 starts from step S100. In step S101, the information terminal apparatus 50 receives the instruction of starting a remote operations panel from an operator. The instruction of starting operations of the remote operations panel can be performed on a screen provided by the remote operations panel unit 154 and exemplified in FIG. 7A.

Referring to FIG. 7A, an initial screen 200 of the remote operations panel displayed on the display unit 64 of the information terminal apparatus 50 is exemplified. The initial screen 200 is provided for starting operations of the remote operations panel by selecting the multifunction peripheral on the connection destination. The initial screen 200 includes a displayed message 202, a connection destination administrating button 204, and connection destination designating buttons 206a and 206b. The connection destination administrating button 204 is provided for receiving an instruction of calling a administration screen for registering or removing a multifunction peripheral being a candidate for the connection destination. Within the first embodiment, the multifunction peripheral of the candidate for the connection destination is previously registered by designating an Internet protocol (IP) address. The connection destination designating button 206 is provided to receive an instruction of starting operations by selecting the connection destination among the previously registered candidates.

When the connection destination designating button 206 illustrated in FIG. 7A is operated (clicking, tapping, or the like), the information terminal apparatus 50 receives the instruction of operating the remote operations panel through which the corresponding multifunction peripheral is designated. Referring again to FIG. 4, in step S102, the information terminal apparatus 50 sends a request for starting an operation to the multifunction peripheral designated as the connection destination. Hereinafter, explanation is given on the premise that the multifunction peripheral 20 is designated as the connection destination. In step S103, the information terminal apparatus 50 receives the screen definition information returned from the multifunction peripheral 20 in response to the operation starting request by the screen definition information receiving portion 160, and stores the received screen definition information in the screen definition information holding unit 162. In step S104, the information terminal apparatus 50 builds the operations screen with the UI building unit 164 in conformity with the description of the received screen definition information. In step S105, the built operations screen is displayed by the UI displaying unit 166.

Referring to FIG. 7A, an initial screen 200 of the remote operations panel displayed on the display unit 64 of the information terminal apparatus 50 is exemplified. Referring to FIG. 7B, the remote operations panel screen 220 includes a disconnecting button 222, an operations screen display area 224, and a start button 226 providing the function of a start key of the multifunction peripheral 20. The disconnection button 222 is provided to receive an instruction of disconnecting the remote operation. Referring to FIG. 7B, a screen exemplifies a flow selection screen for selecting the document delivery flow. On the operations screen display area 224, an operations screen (a flow selection screen) built in conformity with the screen definition information is displayed.

Referring to FIG. 7B, the operations screen includes a title display 230, various buttons 232, 234, and 236, and a tab 238. Referring to FIG. 7B, a “PDF” tab 238a is selected. Buttons 240a to 240d, being equal to one or greater, are arranged. The buttons 240a to 240d are provided to call a setup screen of the delivery flow registered in association with the “PDF” tab 238a. On the screen area of the “PDF” tab 238a, scroll buttons 242 and 244 for switching the button groups of the delivery flow to be displayed are arranged. Referring to FIG. 7B, the first page is displayed and the scroll button 242 is deactivated.

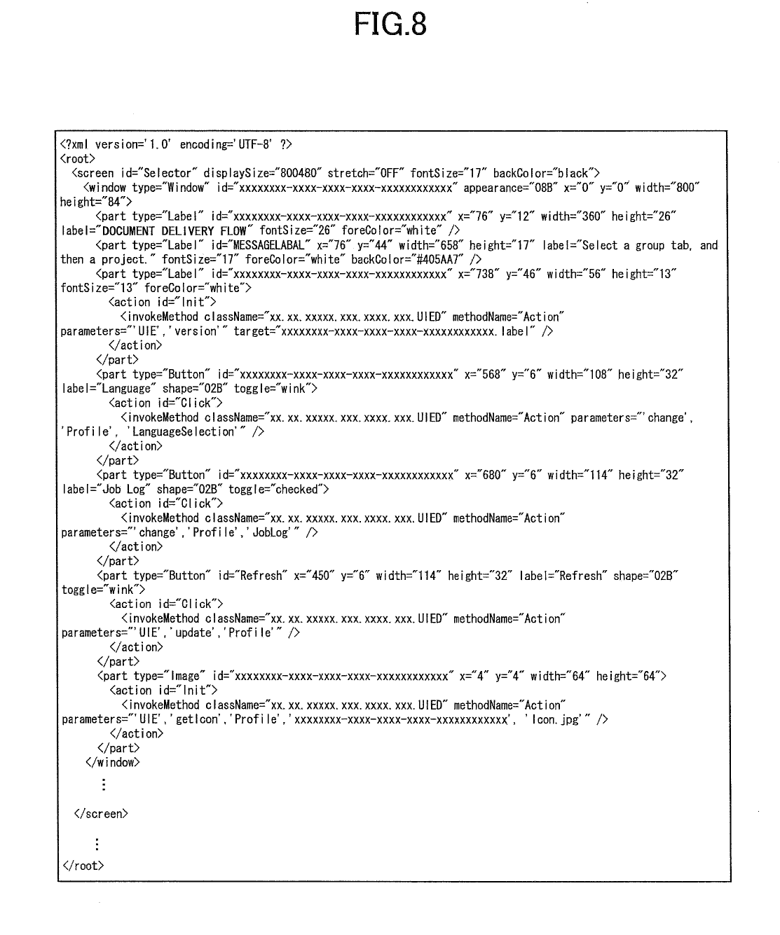

FIG. 8 illustrates an exemplary data structure of the screen definition information of the first embodiment. FIG. 8 illustrates a part of the screen definition information corresponding to the operations screen illustrated in FIG. 7B. Specifically, referring to FIG. 8, the screen definition information includes descriptions of a “Refresh” button 232, a “Language” button 234, and a “Job Log” button 236. Referring to FIG. 8, the screen definition information includes arrangement information describing a display position of the GUI parts in the operations screen and mapping information associating operations to the GUI parts with internal processes called in response to the operations.

Referring back to FIG. 4, in step S106, the information terminal apparatus 50 receives a user operation effected on the remote operations panel screen 220 by the UI operations receiving unit 168. In step S107, the information terminal apparatus 50 judges the user operations and branches the process in response to the types of the events generated by the user operations. The events generated by the user operations can be generally classified into a transition event, a setup event, and an execution event. The transition event is an operation event inducing a screen transition. The transition event includes operations such as a click on a button 240 for calling a setup screen for a specific delivery flow illustrated in FIG. 7B. The setup event is an operations event performing a setup related to the functions. The setup event includes a selection operation and an input operation using a GUI part in the above setup screen. The execution event is an operation event requesting an execution of the function. The execution event includes an operation such as a click of the start button 226 in the remote operations panel screen 220.

In step S107, when the event is judged to be the transition event (transition), the process branches step S108. Then, the process corresponding to the operation of the transition is performed. In step S108, the information terminal apparatus 50 updates an operations screen display area 224 by the UI displaying unit 166 to display the operations screen on the transition destination. In or after step S108, the process is looped back to step S106. In step S106, the process waits on next user operations for the updated operations screen.

On the other hand, in step S107, if it is judged that the event is the setup event (setup) instead of the execution event, the process branches step S109 and the process corresponding to the operation of the setup is performed. In step S109, the information terminal apparatus 50 stores the setup information describing the content selected or input using the GUI parts by the UI operations receiving unit 168 in the setup information holding unit 170. In or after step S109, the process is looped back to step S106. In step S106, the process waits on next user operations for the updated operations screen.

On the other hand, in step S107, if it is judged that the event is the execution event (execution), the process branches step S110 and the process corresponding to the operation of the setup is performed. In step S110, the information terminal apparatus 50 sends the execution request and the setup information to the multifunction peripheral 20 on the connection destination by the operations information sending unit 172. In step S111, the information terminal apparatus 50 receives an execution result reported from the multifunction peripheral 20 in response to the execution request. In step S112, the execution result such as a completion notice to a user is displayed in step S112. In or after step S112, the process branches again to step S106, where a screen transition is caused so that the initial flow selection screen illustrated in, for example, FIG. 7B is displayed.

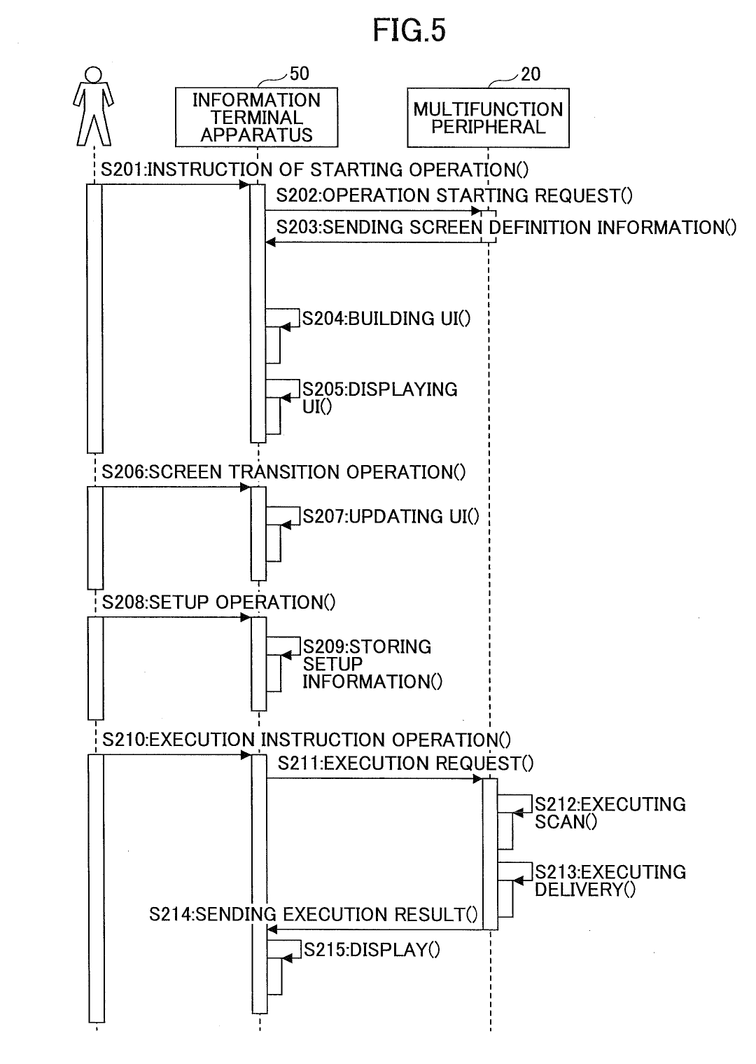

FIG. 5 is a sequence chart illustrating a screen display operating process performed between a multifunction peripheral 20 and the information terminal apparatus 50 of the first embodiment. The process illustrated in FIG. 5 starts from the step S201. In step S201, the information terminal apparatus 50 receives the instruction of starting an operation of a remote operations panel from an operator. In step S202, the information terminal apparatus 50 sends a message of a operation starting request to an IP address of the multifunction peripheral 20 designated as the connection destination. In step S203, the multifunction peripheral 20 sends the screen definition information held by the multifunction peripheral 20 to the information terminal apparatus 50 in response to the message of the operation starting request. In step S204, the information terminal apparatus 50 builds an operations screen in conformity with the received screen definition information (building UI). In step S205, the built operations screen is displayed (displaying UI).

In step S206, the information terminal apparatus 50 receives the screen transition operation from the operator. In step S207, the information terminal apparatus 50 displays a portion of the screen definition information corresponding to a screen on the transition destination in response to the transition event generated by the screen transition operation. Thus, the screen is updated (updating UI). By the screen transition, the operations screen for selecting the various attributes in the delivery flow is displayed.

In step S208, the information terminal apparatus 50 receives a setup operation from the operator. In step S209, the information terminal apparatus 50 stores the setup information input through the operations screen. In steps S208 and S209, designation of the scanning resolution, for example, designation of both sides or a single side.

In step S210, the information terminal apparatus 50 receives the execution instruction operation in the remote operations panel. As the execution instruction operation through the remote operations panel screen 220 illustrated in FIG. 7B, a click, a double-click, a tap, a shortcut key operation connected to a command calling the execution request, and a multi-touch gesture connected to a command calling the execution request on a start button 226. In step S211, the information terminal apparatus 50 sends the execution request and the setup information stored in step S209 to the multifunction peripheral 20.

On the side of the multifunction peripheral 20 receiving the execution request, various processes in the called delivery flow is performed. Referring to FIG. 5, the multifunction peripheral 20 scans in conformity with scanning conditions designated in the setup information in step S212. In step S213, the multifunction peripheral 20 performs a delivery process to a delivery destination designated in the setup information by a delivery method designated in the setup information. In step S214, the multifunction peripheral 20 sends an execution result (a report) of the process of the delivery flow to the information terminal apparatus 50 indicating that all the processes in the delivery flow succeeded. In step S215, the information terminal apparatus 50 displays the received execution result on the display unit 64. Then, the process is completed.

Within the first embodiment illustrated in FIG. 5, the screen definition information is provided as a single file describing plural operations screens, and the screen transition is performed to draw and update the screen on the transition destination in conformity with the description of corresponding portions in the screen definition information previously acquired. On the side of the information terminal apparatus 50, the screen transition is appropriately performed using the screen definition information of the single file, and the setup content set by the operations screens being equal to one or greater and the execution request are simultaneously transmitted on the side of the multifunction peripheral 20. However, the transmission method of the contents of operations between the information terminal apparatus 50 and the multifunction peripheral 20 is not limited to the way illustrated in FIG. 5.

### Second Embodiment

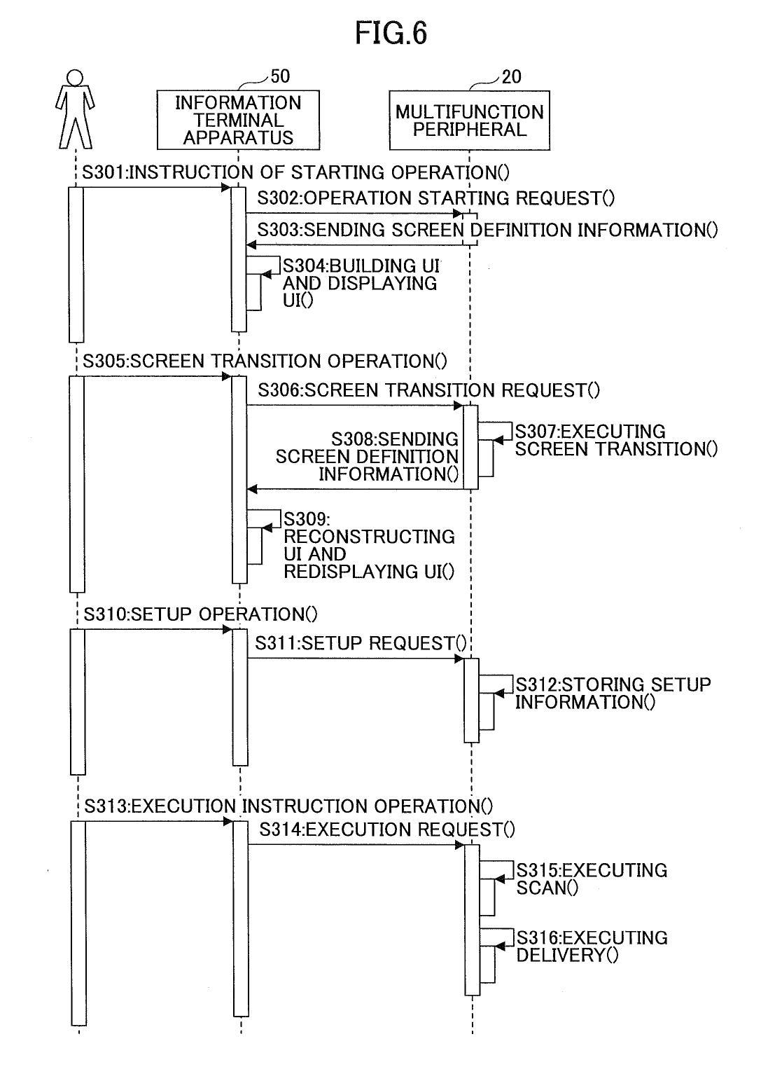

FIG. 6 is a sequence chart illustrating a screen display operating process performed between the multifunction peripheral 20 and the information terminal apparatus 50 of a modified example of the first embodiment. Referring to FIG. 6, the screen definition information is structured as a file for each operations screen. The contents of operations from the information terminal apparatus 50 are continually transmitted to the side of the multifunction peripheral 20. The process illustrated in FIG. 6 is started from step S301.

In step S301, the information terminal apparatus 50 receives the instruction of starting an operation from the operator. In step S302, the information terminal apparatus 50 sends a message of a operation starting request to the multifunction peripheral 20 designated as the connection destination. In step S303, the multifunction peripheral 20 sends the screen definition information, in which the operations screen currently displayed on the operations panel unit 34 of the multifunction peripheral 20 is described, to the information terminal apparatus 50 in response to the message of the operation starting request. In step S304, the information terminal apparatus 50 builds an operations screen in conformity with the received screen definition information, and displays the built operations screen (building and displaying UI).

In step S305, the information terminal apparatus 50 receives the screen transition operation from the operator. In step S306, the information terminal apparatus 50 sends a message of a screen transition request to the multifunction peripheral 20 in response to a transition event generated by a screen transition operation. In step S307, the multifunction peripheral 20 executes the screen transition from the operations screen currently displayed in response to the message of the screen transition request. In step S308, the multifunction peripheral 20 sends the screen definition information in which the screen on the transition destination is described to the information terminal apparatus 50. In step S309, the information terminal apparatus 50 builds an operations screen in conformity with the received screen definition information in which the screen on the transition destination is described, and displays the built operations screen again (reconstructing UI and redisplaying).

In step S310, the information terminal apparatus 50 receives a setup operation from the operator. In step S311, the information terminal apparatus 50 sends a message of screen transition request 50 including the setup information to the multifunction peripheral 20 in response to a setup event generated by a setup operation. In step S312, the multifunction peripheral 20 stores the sent setup information.

In step S313, the information terminal apparatus 50 receives an execution instruction operation. In step S314, the information terminal apparatus 50 sends the execution request to the multifunction peripheral 20. On the side of the multifunction peripheral 20 receiving the execution request, various processes in the called delivery flow is performed. Referring to FIG. 6, in step S315, the multifunction peripheral 20 scans using scanning conditions designated by the setup information stored in step S312. In step S316, the multifunction peripheral 20 performs a delivery process using conditions designated by the setup information. After the execution result is appropriately sent and displayed, the process is completed.

As described, in the document delivery system 10 of the first embodiment, the UI for operating the multifunction peripheral 20 is displayed on the display unit 64 of the information terminal apparatus 50 which is connected to the multifunction peripheral 20 via the network 12. Thus, it is possible to perform an input operation from an input unit 62 of the information terminal apparatus 50 to the multifunction peripheral 20. Therefore, even if an operations panel unit having drawing performance limited in displaying UI (including no display device) is installed in the multifunction peripheral, it is possible to display the operations screen on the information terminal apparatus 50 in a suitable mode irrespective of the drawing performance of the display device installed in the multifunction peripheral. Thus, it is possible to call functions provided by the multifunction peripheral from the information terminal apparatus 50.

Within the first embodiment, the operations screen displayed on the side of the information terminal apparatus 50 is built so as to fit the drawing performance of the display unit 64 of the information terminal apparatus 50. Hereinafter, a second embodiment is described. Within the second embodiment, the operations screen can be modified in response to the function properties provided in the multifunction peripheral 20. Within the second embodiment, the structure is substantially similar to that of the first embodiment. Hereinafter, differences are mainly explained.

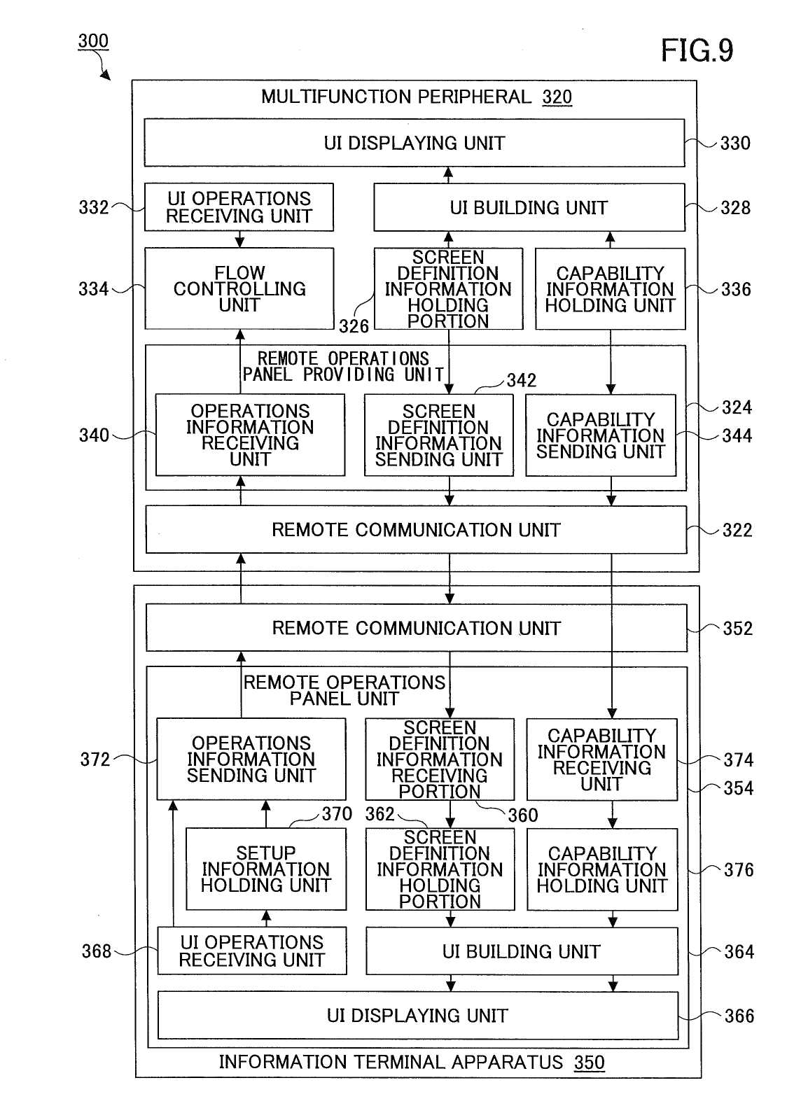

Hereinafter, referring to FIGS. 9 to 12, details of the remote operations function of the document delivery system 10 of the second embodiment are described. FIG. 9 illustrates a functional block realized by the document delivery system of the second embodiment. The functional block 300 illustrated in FIG. 9 includes a functional block 320 realized in the multifunction peripheral 20 and a functional block 350 realized in an information terminal apparatus 50.

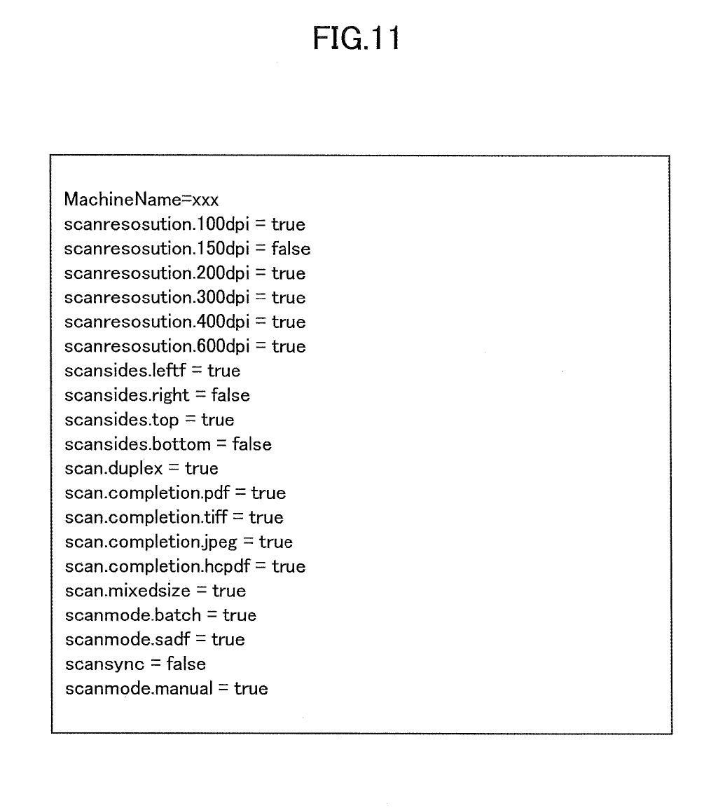

In a manner similar to the first embodiment, the functional block 320 of the multifunction peripheral 20 includes a remote communication unit 322, a remote operations panel providing unit 324, a screen definition information holding unit 326, a UI building unit 328, a UI displaying unit 330, a UI operations receiving unit 332, a flow controlling unit 334, and a capability information holding unit 336. The capability information holding unit 336 holds capability information describing function properties provided in the multifunction peripheral 20. The capability information describes whether the function properties exists as illustrated in FIG. 11. For example, the capability information is prepared in response to the specifications of the multifunction peripheral 20 in advance.

The UI building unit 328 reads out screen definition information held by the screen definition information holding unit 326 and capability information held by the capability information holding unit 336. The UI building unit 328 builds the operations screen in accordance with the description of the screen definition information and the capability information. The remote operations panel providing unit 324 of the second embodiment includes an operations information receiving unit 340, a screen definition information sending unit 342, and a capability information sending unit 344. The capability information sending unit 344 sends the capability information held by the capability information holding unit 336 to the information terminal apparatus 50 connected to the remote operations function.

The functional block 350 of the information terminal apparatus 50 includes a remote communication unit 352 and a remote operations panel unit 354. In a manner similar to the first embodiment, the remote operations panel unit 354 includes a screen definition information receiving portion 360, a screen definition information holding unit 362, a UI building unit 364, a UI displaying unit 366, a UI operations receiving unit 368, a setup information holding unit 370, and an operations information sending unit 372. The remote operations panel unit 354 further includes a capability information receiving unit 374 and a capability information holding unit 376.

The capability information receiving unit 374 receives the capability information sent from the capability information sending unit 344 of the multifunction peripheral 20. The capability information holding unit 376 holds the received capability information. The UI building unit 364 reads the screen definition information held by the screen definition information holding unit 362 and the capability information held by the capability information holding unit 376. The UI building unit 364 builds the operations screen by fitting it to the drawing performance of the display unit 64 of the information terminal apparatus 50 and reflecting function properties (a scanning resolution which can be set or a paper size) of the multifunction peripheral 20 on it. The UI displaying unit 366 displays the built operations screen on the display unit 64.

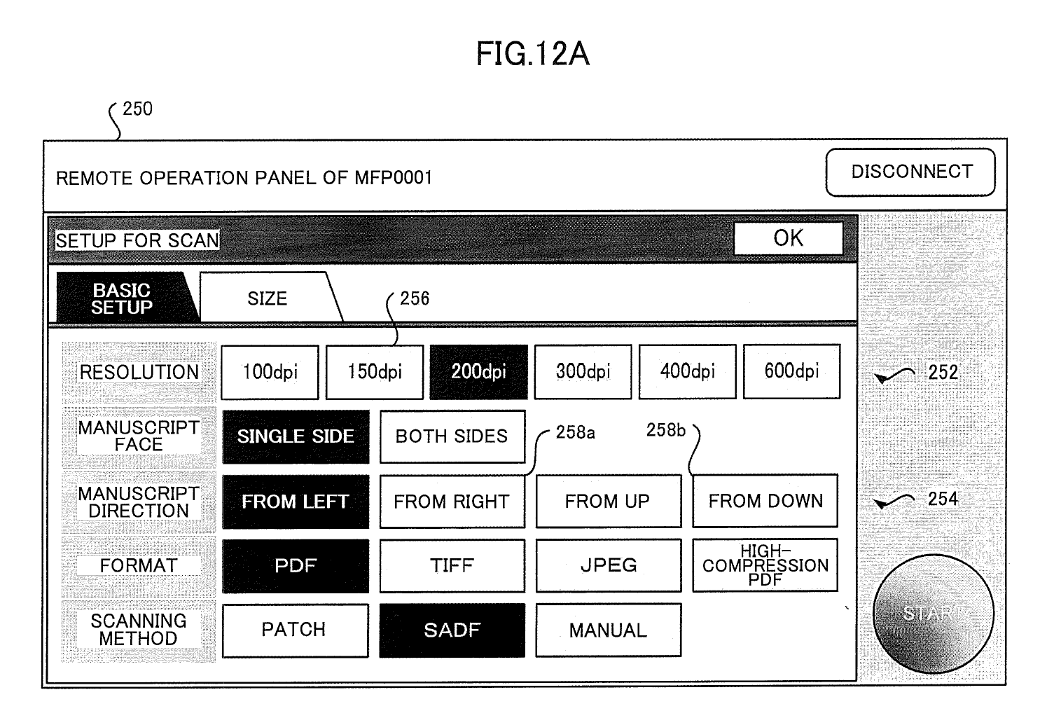

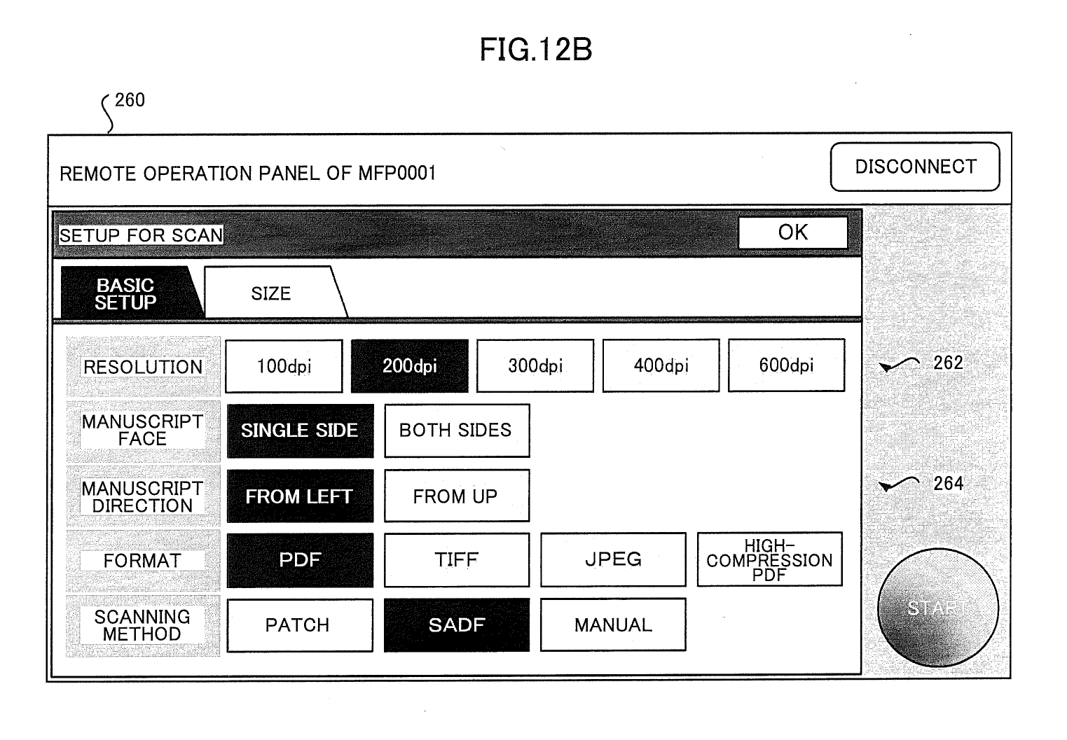

FIG. 12 illustrates a remote operations panel screen displayed on a display unit 64 of the information terminal apparatus 50. FIG. 12A exemplifies the operations screen built without using the capability information. FIG. 12B exemplifies the operations screen built using the capability information illustrated in FIG. 11.

On a screen 250 illustrated in FIG. 12A, all options including 150 dpi are displayed in an options group 252 of the resolutions. On a screen illustrated in FIG. 12B, the option 256 for 150 dpi is hidden in the options group 262 in conformity with the description “scanresolution. 150 dpi=false”. In a manner similar to the above, all options including “from right” 258a and “from down” 258b are displayed. On the contrary, on the screen 260 illustrated in FIG. 12B, only two options of “from left” and “from up” are displayed.

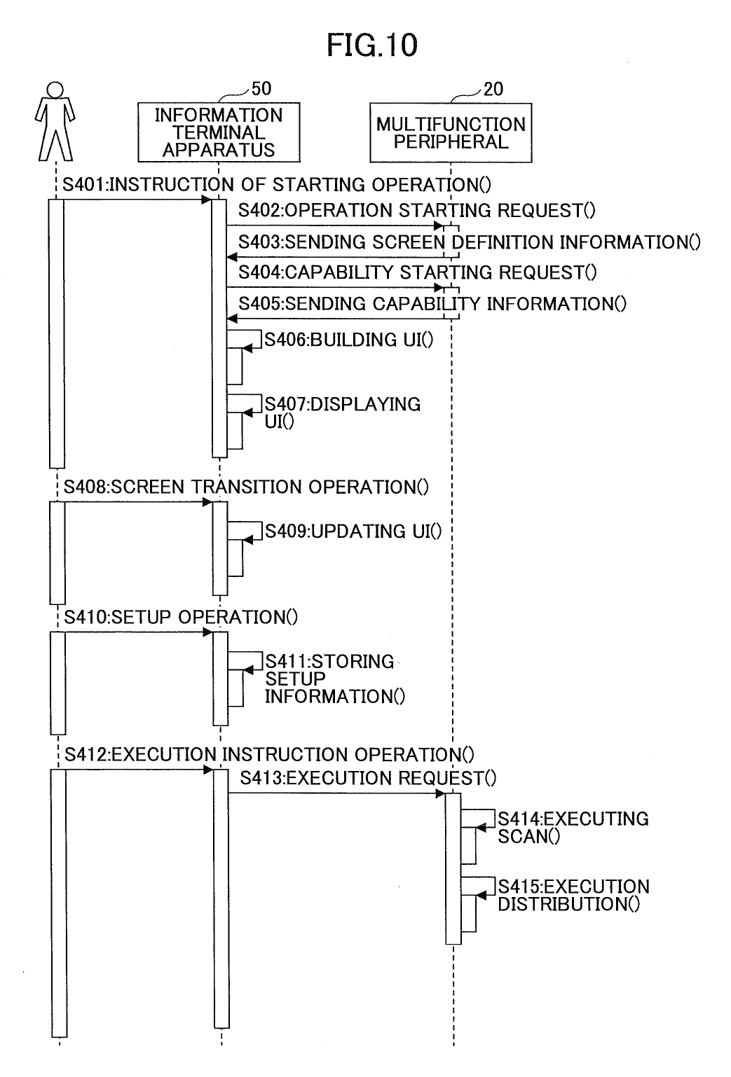

FIG. 10 is a sequence chart illustrating a screen display operating process performed between the multifunction peripheral 20 and the information terminal apparatus 50 of the second embodiment. The process illustrated in FIG. 10 starts from the step S401. In step S401, the information terminal apparatus 50 receives the instruction of starting the operation from the operator. In step S402, the information terminal apparatus 50 sends a message of a operation start request to the multifunction peripheral 20 as the connection destination. In step S403, the multifunction peripheral 20 sends the screen definition information to the information terminal apparatus 50. In step S404, the information terminal apparatus 50 further sends a message of a capability information request. In step S405, the multifunction peripheral 20 sends capability information to the information terminal apparatus 50 in response to the message of the capability information request 20.

In step S406, the information terminal apparatus 50 builds the operations screen in conformity with the received screen definition information and the capability information (building UI). In step S407, the built operations screen is displayed (displaying UI). The following processes are similar to the process flow illustrated in steps S206 to S215 of FIG. 5. Therefore, explanation of the following processes is omitted.

Within the second embodiment, in the document delivery system, the operations screen on which function properties in the multifunction peripheral are reflected is displayed by the information terminal apparatus 50 to enable the input operations of the multifunction peripheral 20. Since the option which is not provided in the multifunction peripheral is hidden on the operations screen of the second embodiment, it is possible to appropriately prevent the operator from erroneously deleting an option of the function properties which is not provided in the multifunction peripheral.

Within the first and second embodiments, an input operation via the operations panel unit 34 from the information terminal apparatus 50 is not specifically limited. On the other hand, while the operation is done on the information terminal apparatus 50, it may be preferable to limit an input operation via the operations panel unit 34 of the multifunction peripheral 20 or the like as an exclusive operation.

### Third Embodiment

Hereinafter, there is described a third embodiment in which an input operation via the operations panel unit 34 included in the multifunction peripheral 20 is limited in response to the request for starting the exclusive operation from the information terminal apparatus 50. Within the third embodiment, the structure is substantially similar to that of the first embodiment. Hereinafter, differences are mainly explained.

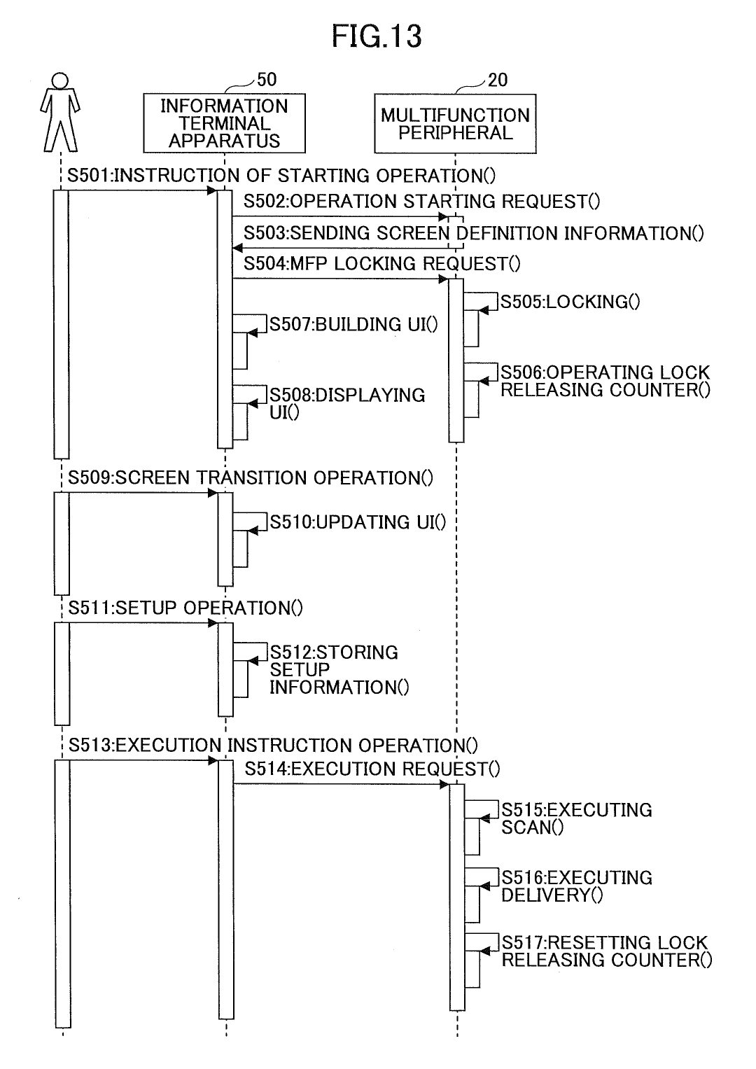

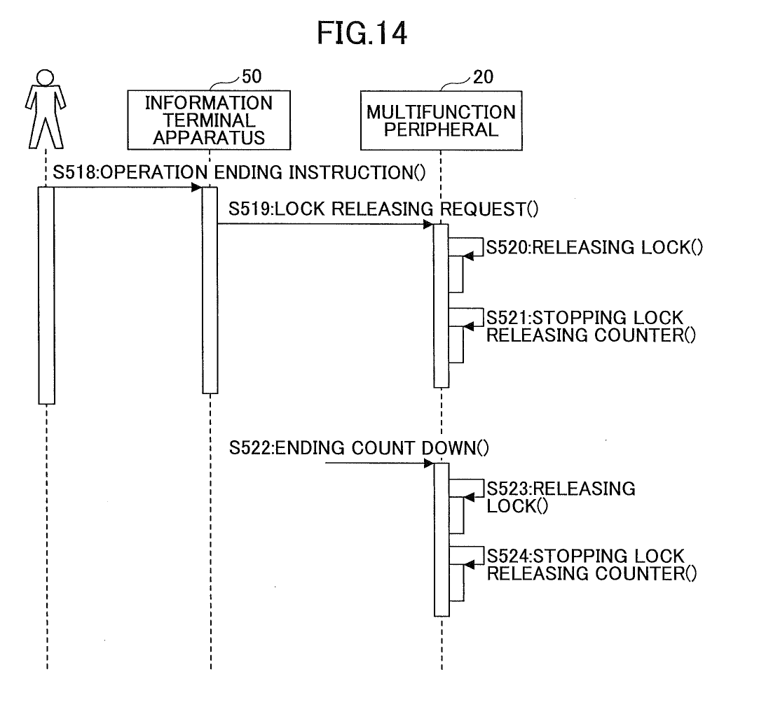

Referring to FIGS. 13 and 14, within the third embodiment, the process in the remote operations function performed between the information terminal apparatus 50 and the multifunction peripheral 20 is described in detail. FIGS. 13 and 14 are a sequence chart illustrating a screen display operating process performed between the multifunction peripheral 20 and the information terminal apparatus 50 of the third embodiment. The process illustrated in FIGS. 13 and 14 is started from step S501.

In step S501, the information terminal apparatus 50 receives the instruction of starting an operation from the operator. Within the third embodiment, the above instruction requests to limit an input operation via the operations panel unit included in the multifunction peripheral as the connection destination. In step S502, the information terminal apparatus 50 sends a message of a operation starting request to the multifunction peripheral 20 as the connection destination. In step S503, the multifunction peripheral 20 sends the screen definition information to the information terminal apparatus 50.

In step S504, the information terminal apparatus 50 further sends a message of a multifunction peripheral locking request to the multifunction peripheral 20. In step S505, the multifunction peripheral 20 performs a locking process for limiting an input operation via the operations panel unit 34 of the multifunction peripheral 20 in response to a multifunction peripheral locking request message. In step S506, the multifunction peripheral 20 operates a lock releasing timer in which a predetermined set time is set. The lock releasing timer assumes that a connection with the information terminal apparatus is cut when an idle state, in which no operation is given from the remote operations panel, continues for a predetermined period to thereby release the limitation of the input operation via the operations panel unit 34. On the other hand, in step S507, the information terminal apparatus 50 builds an operations screen in conformity with the received screen definition information (building UI). In step S508, the built operations screen is displayed (displaying UI).

The process flow in steps S509 to S512 is similar to the process in steps S206 to S209 illustrated in FIG. 5. Therefore, the explanation is omitted. In step S513, the information terminal apparatus 50 receives an execution instruction operation from the operator. In step S514, the information terminal apparatus 50 sends an execution request and setup information to the multifunction peripheral 20. When the multifunction peripheral 20 receives the execution request, the multifunction peripheral 20 scans in step S515 and performs a delivery process. When the execution request is performed, the process is at least not in an idle state. In step S517, the multifunction peripheral 20 resets the lock releasing timer operated in step S506.

In step S518, the information terminal apparatus 50 receives an operation ending instruction from the operator. The operation ending instruction requests a release of the input operation via the operations panel unit 34 of the multifunction peripheral 20. In step S519, the information terminal apparatus 50 sends a message of lock releasing request to the multifunction peripheral 20. In step S520, the multifunction peripheral 20 releases the limitation of the input operation via the operations panel unit 34 of the multifunction peripheral 20 by releasing the lock in response to the message of the lock releasing request. In step S521, the multifunction peripheral 20 stops the lock releasing timer.

If the countdown ends in step S522. In step S523, the multifunction peripheral 20 releases locking to thereby release the limitation of the input operation via the operations panel unit 34 of the multifunction peripheral 20. In step S524, the lock releasing timer is stopped.

Within the third embodiment, in the document delivery system, when the input operation is in effect on the multifunction peripheral 20 from the information terminal apparatus 50, it is possible to limit the operation from the operation panel unit of the multifunction peripheral 20. With this, it is possible to prevent the information terminal apparatus 50 from being unexpectedly operated from the multifunction peripheral 20 while the information terminal apparatus 50 is operated. The limitation of the input operation via the operations panel unit 34 included in the multifunction peripheral 20 is released in response to a passage of a preset time or a receipt of an explicit request for releasing the limitation. Therefore, it is possible to preferably prevent a limitation of the operation of the multifunction peripheral 20 for a long time even when no one originally operates the information terminal apparatus 50.

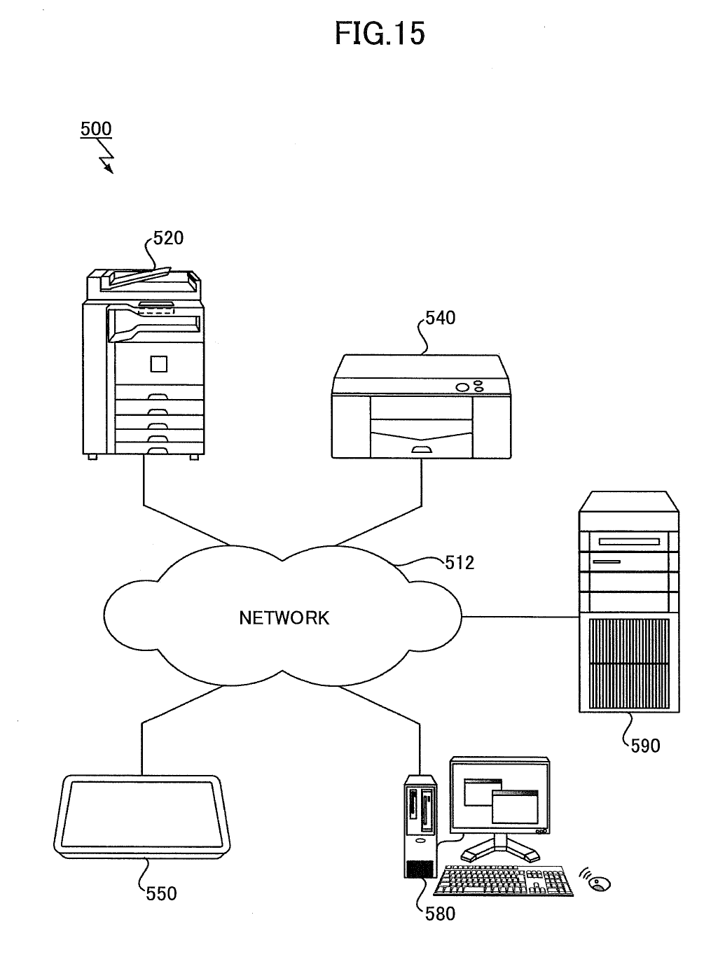

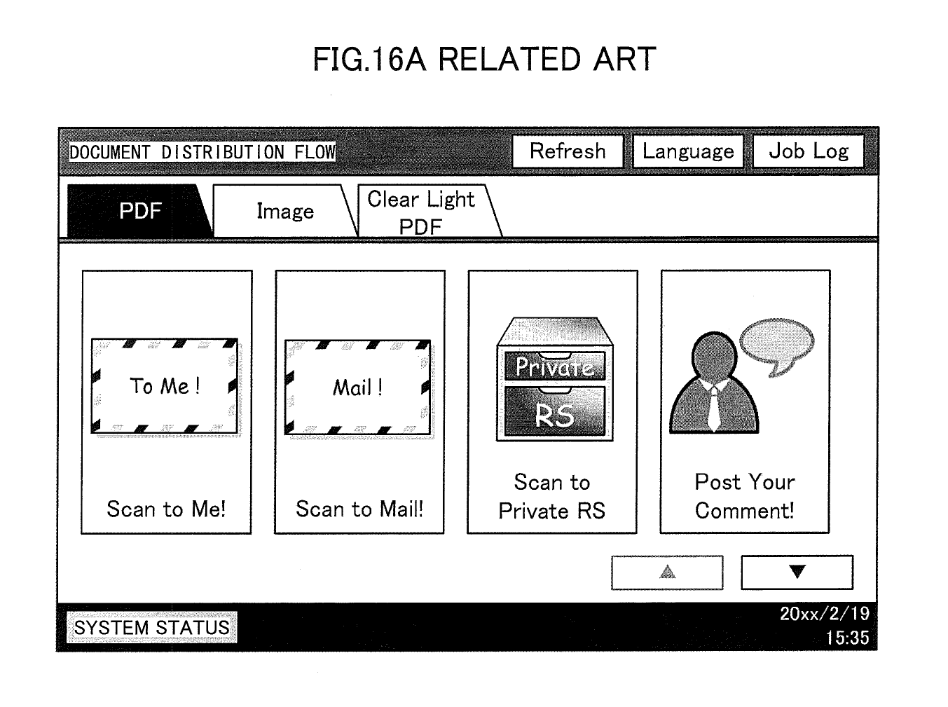

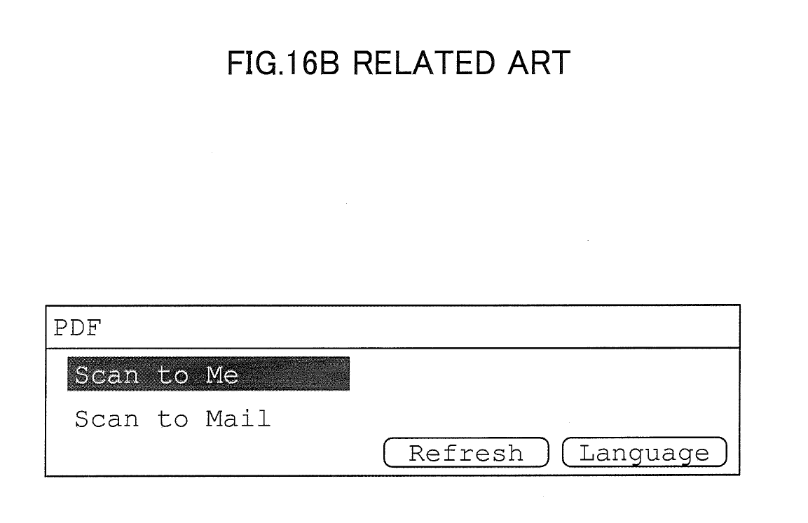

Within the embodiments, the document delivery system including a multifunction peripheral, an information terminal apparatus, and an administrating control terminal, which are mutually connected via a network, has been described as an example. However, the structure of the document delivery system is not specifically limited. Referring to FIG. 15, a server administrating plural multifunction peripherals may be prepared in response to the system scale of the document delivery system. Referring to FIG. 15, the document delivery system 500 receives delivery of the above screen definition information and the above flow definition information via a document delivery server 590 from an administrating control terminal 580. The multifunction peripherals 520 and 540 functions as image input apparatuses. A part of the process having a high load on the flow can be shifted to the side of the document delivery server 590.

As described above, within the above embodiments, it is possible to provide an image processing system, an information terminal apparatus, and an image displaying method, by which the operations screens of the image processing apparatus are displayed on the information terminal apparatus connected via the network and input operations to the image processing apparatus are enabled.

The above mentioned functional parts may be realized by a program executed by a computer described by a legacy programming language or an object-oriented programming such as an assembler, C language, C++ language, C# language, Java (“Java” is a registered trademark), stored in a readable recording medium such as ROM, EEPROM, EPROM, a flash memory, a flexible disk, a CD-ROM, a CD-RW, a DVD-ROM, a DVD-RAM, a DVD-RW, a Blu-ray disk, an SD card, and an MO, or distributed via a telecommunications circuit.

With the above structure, in the image processing system, the operations screen for operating the first apparatus are displayed on the second apparatus connected to the first apparatus via the network thereby enabling an input operation from the second apparatus to the first apparatus. Therefore, regardless of the drawing performance of the first apparatus, it is possible to call the functions provided by the first apparatus using the operations screen.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although an image processing system has been described in detail, it should be understood that various changes, substitutions, and alterations could be made thereto without departing from the spirit and scope of the invention.

This patent application is based on Japanese Priority Patent Application No. 2012-017985 filed on Jan. 31, 2012, the entire contents of which are hereby incorporated herein by reference.

What is claimed is:

1. An image processing system comprising:
a first apparatus; and
a second apparatus connected to the first apparatus via a network,
wherein the first apparatus includes
a screen definition information sending unit configured to send screen definition information defining an operations screen for using a function, which can be used, from the first apparatus to the second apparatus,
an operations information receiving unit configured to receive an execution request issued on the second apparatus using the operations screen, and
an execution controlling unit configured to control execution of the function in response to the execution request,
wherein the second apparatus includes
a building unit configured to build the operations screen in conformity with the screen definition information which is received,
an operations receiving unit configured to receive an operation using the operations screen, and
an operations information sending unit configured to send the execution request to the first apparatus in response to an execution instruction operation for requesting the first apparatus to execute the function based on the operation received by the operations receiving unit.

2. The image processing system according to claim 1,
wherein the second apparatus further includes
a judging unit configured to determine whether the operation received by the operations receiving unit is the execution instruction operation for requesting the first apparatus to execute the function based on the operation received by the operations receiving unit, and
an executing unit configured to execute a process corresponding to the operation in a case where the judging unit judges that the operation is not the execution instruction operation for requesting the first apparatus to execute the function,
wherein the operations information sending unit is activated in a case where it is judged by the judging unit that the operation is the execution instruction operation.

3. The image processing system according to claim 2,
wherein the second apparatus further includes
a setup information holding unit holding setup information,
wherein the function executed based on the operation is set during the process corresponding to the operation,
the executing unit causes the setup information holding unit to hold the setup information when the set function executed based on the operation is the process corresponding to the operation, and
the operations information sending unit sends the setup information held by the setup information holding unit and the execution request to the first apparatus.

4. The image processing system according to claim 1,
wherein the first apparatus further includes
a capability information sending unit configured to send capability information, in which function properties provided in the first apparatus is described, to the second apparatus,
wherein the building unit builds the operations screen by reflecting the capability information to the operations screen.

5. The image processing system according to claim 1,
wherein the first apparatus further includes
an input device for inputting the operation,
wherein the first apparatus limits an input operation via the input device in response to receipt of a request for starting an exclusive operation from the second apparatus.

6. The image processing system according to claim 5,
wherein the first apparatus limits the input operation via the input device in response to a passage of a predetermined time or a receipt of an explicit request for releasing from limiting the input operation.

7. The image processing system according to claim 1,
wherein the function, which can be used, is a document delivery flow for delivering the input image input into the first apparatus.

8. The image processing system according to claim 1,
wherein, in a case where the operation performed using the operations screen is a screen transition operation inducing a screen transition, the operations screen is updated after a screen transition or the second apparatus sends a screen transition request to the first apparatus and newly acquires the screen definition information defining the operations screen after the transition.

9. An information terminal apparatus connected to an external apparatus via a network, the information terminal apparatus comprising:
a screen definition receiving unit configured to receive screen definition information defining an operations screen for using a function which can be used by the external apparatus;
a building unit configured to build the operations screen in conformity with the screen definition information which is received;
an operations receiving unit configured to receive an operation using the operations screen; and
an operations information sending unit configured to send an execution request to the external apparatus in response to an execution instruction operation for requesting the external apparatus to execute the function in response to the execution request based on the operation received by the operations receiving unit.

10. An image displaying method performed by a first apparatus and a second apparatus connected to the first apparatus via a network, the image displaying method comprising:
sending, by the first apparatus, screen definition information defining an operations screen for using a function, which can be used, from the first apparatus to the second apparatus;
building, by the second apparatus, an operations screen in conformity with the screen definition information;
sending, by the second apparatus, an execution request to the first apparatus in response to an execution instruction operation input in the built operations screen; and
calling, by the first apparatus, the function in response to the received execution request.
